(19) United States
(12) Patent Application Publication
(10) Pub. No.: US 2009/0114341 A1
(43) Pub. Date: May 7, 2009

(54) PROCESS FOR PRODUCTION OF MOLDINGS AND MOTOR VEHICLES

(75) Inventors: Yasuo Suzuki, Shizuoka (JP); Naohiro Morozumii, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 11/718,651

(22) PCT Filed: Jul. 11, 2006
(86) PCT No.: PCT/JP2006/313745

§ 371 Date: May 4, 2007

(30) Foreign Application Priority Data
Jul. 25, 2005 (JP) 2005-213719

(51) Int. Cl. C09J 5/00

(52) U.S. Cl. 156/322

(57) ABSTRACT

A method of making a decorated formed product effectively using a decorative sheet without diminishing the beauty of its appearance includes the steps of: (A) providing a formed product body; (B) mounting a first sheet, including an adhesive layer, on the formed product body; (C) heating a second sheet including a decoration layer and a base member that supports the decoration layer thereon; and (D) putting the heated second sheet on the first sheet, thereby bonding the second sheet onto the formed product body.

### BACKGROUND OF THE INVENTION

1. Field of the Invention

The present invention relates to a method of making a decorated formed product with a decorated surface and more particularly relates to a method of making a formed product that can be used effectively as an exterior or interior member for a motor vehicle.

2. Description of the Related Art

Recently, it was proposed that a decorative sheet be attached to the surface of a formed product as a technique of decorating various types of formed products. A formed product with a decorative sheet can be recycled more easily than a formed product with a painted surface. In addition, a decorated product can have a different type of fine appearance from that of a painted product. That is why a decorative sheet contributes to improving the appearance of formed products noticeably.

FIG. 11 shows an example of a decorative sheet. The decorative sheet 110 shown in FIG. 11 includes a base member 1 of a resin material, a decoration layer 2 arranged on the principal surface 1a of the base member 1, and an adhesive layer 4 provided on the decoration layer 2. The decoration layer 2 may be formed by a printing process, for example. The adhesive layer may be formed by dry-laminating a resin adhesive, for instance. By attaching this decorative sheet 110 to the surface of the body 121 of a formed product in the order shown in FIGS. 12(a), 12(b) and 12(c), a decorated formed product 120 with a decorated surface can be obtained.

The formed product body 121 shown in FIG. 12(a) includes a hemispherical (cuplike) raised portion 121a and therefore has a rugged surface. For that reason, the decorative sheet 110 being attached is stretched so as to follow such ruggedness perfectly. To stretch the decorative sheet 110 effectively, the decorative sheet 110 is typically heated and softened before being attached. A vacuum forming system for making a decorated formed product 120 such as that shown in FIG. 12(c) by using the decorative sheet 110 is disclosed in Japanese Patent Application Laid-Open Publication No. 2002-79573.

If a decorative sheet is attached to a formed product with a rugged surface, however, the resultant decorated formed product may have an uneven gloss on the surface, thus possibly diminishing the beauty of its appearance. FIG. 13 shows a motorcycle fender 122 decorated with the decorative sheet 110. As shown in FIG. 13, a string of uneven gloss 123 appears on a part of the surface of the fender 122 to ruin the beautiful appearance thereof.

### SUMMARY OF THE INVENTION

In order to overcome the problems described above, preferred embodiments of the present invention provide a method of making a decorated formed product effectively without diminishing the beauty of its appearance even when a decorative sheet is used.

A formed product making method according to a preferred embodiment of the present invention is a method of making a decorated formed product with a decorated surface. The method includes the steps of: (A) providing a formed product body; (B) mounting a first sheet, including an adhesive layer, on the formed product body; (C) heating a second sheet including a decoration layer and a base member that supports the decoration layer thereon; and (D) putting that heated second sheet on the first sheet, thereby bonding the second sheet onto the formed product body.

In a preferred embodiment, the first sheet further includes a supporting layer that supports the adhesive layer, and the formed product making method of the present invention further includes the step (E) of removing the supporting layer from the adhesive layer before the step (D) is performed.

In a preferred embodiment, the formed product making method of the present invention further includes the step (F) of heating the first sheet before the step (B) is performed.

In a preferred embodiment, the step (D) includes the steps of: (D1) bringing the heated second sheet closer to the formed product body; and (D2) creating a lower pressure in a first space, which is defined between the second sheet that is now located near the formed product body and the formed product body itself, than in a second space, which is defined on the opposite side of the second sheet over or under the first space.

In a preferred embodiment, the step (D) includes forming the second sheet such that the second sheet covers the surface of the formed product body tightly.

In a preferred embodiment, the melting point of the adhesive layer is lower than the glass transition temperature of the base member by at least about 30° C.

In a preferred embodiment, the adhesive layer is made of a material that has an elasticity falling within the range of approximately 1×103 Pa to 1×106 Pa at 80° C. and within the range of approximately 1×101 Pa to 1×105 Pa at 180° C.

In a preferred embodiment, the base member is made of a thermoplastic resin.

In a preferred embodiment, the formed product body has been formed by a deep-drawing process and has such a shape that a draw diameter L and a draw depth D satisfy L≧100 mm and D/L≧⅓.

A motor vehicle according to a preferred embodiment of the present invention includes a formed product that is formed by one of the methods described above.

In a method of making a formed product according to a preferred embodiment of the present invention, a first sheet including an adhesive layer is mounted on a formed product body first, and then a second sheet including a decoration layer is put on the first sheet, thereby adhering the second sheet and the formed product body together. That is why the adhesive is rarely distributed unevenly and a string of uneven gloss can be virtually eliminated. Consequently, according to preferred embodiments of the present invention, a formed product decorated with a decorative sheet can be made effectively without diminishing the beauty of its appearance.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 schematically illustrates a vacuum forming system for use in a method of making a decorated formed product according to a preferred embodiment of the present invention.

FIGS. 2(a) and 2(b) are cross-sectional views schematically illustrating processing steps of a decorated formed product manufacturing process.

FIGS. 3(a) and 3(b) are cross-sectional views schematically illustrating processing steps of the decorated formed product manufacturing process.

FIGS. 4(a) and 4(b) are cross-sectional views schematically illustrating processing steps of the decorated formed product manufacturing process.

FIGS. 5(a) and 5(b) are cross-sectional views schematically illustrating processing steps of the decorated formed product manufacturing process.

FIGS. 6(a) and 6(b) are cross-sectional views schematically illustrating processing steps of the decorated formed product manufacturing process.

FIGS. 7(a) and 7(b) are cross-sectional views schematically illustrating processing steps of the decorated formed product manufacturing process.

FIG. 8 is a perspective view illustrating an exemplary decorative sheet for use in a method of making a decorated formed product according to a preferred embodiment of the present invention.

FIG. 9(a) is a perspective view illustrating an example of a decorated formed product formed by the decorated formed product manufacturing process according to a preferred embodiment of the present invention and FIG. 9(b) is a cross-sectional view of the product as viewed on the plane 9B-9B′ shown in FIG. 9(a).

FIG. 10 is a side view schematically illustrating a motorcycle.

FIG. 11 is a perspective view schematically illustrating a decorative sheet for use in a conventional method of making a decorated formed product.

FIGS. 12(a) through 12(c) illustrate a conventional decorated formed product manufacturing process.

FIG. 13 is a perspective view illustrating a motorcycle fender made by the conventional decorated formed product manufacturing process.

FIGS. 14(a) through 14(c) illustrate another conventional decorated formed product manufacturing process.

### DETAILED DESCRIPTION OF PREFERRED EMBODIMENTS

Hereinafter, preferred embodiments of the present invention will be described with reference to the accompanying drawings. It should be noted, however, that the present invention is in no way limited to the following specific preferred embodiments.

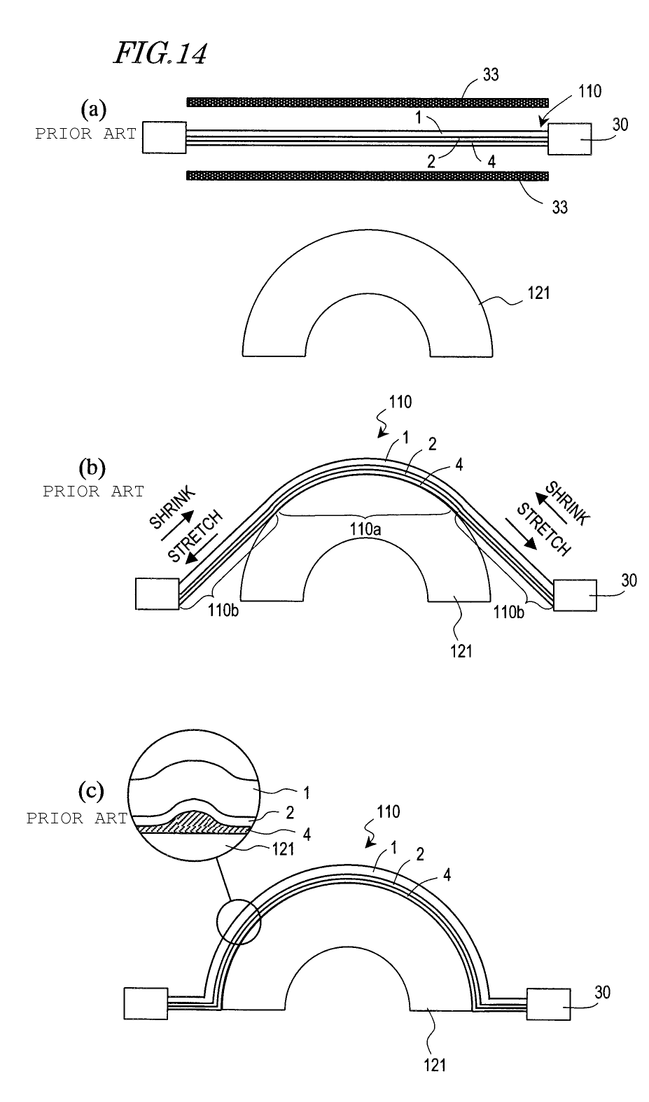

First of all, it will be described why the uneven gloss is produced by the conventional method. FIGS. 14(a) through 14(c) illustrate a conventional decorated formed product manufacturing process.

According to the conventional method, first, as shown in FIG. 14(a), a decorative sheet 110 is fixed onto a gripping frame 30 and then heated with a heater 33. In this process step, the decorative sheet 110 is heated to a temperature at which the base member 1 softens sufficiently and the adhesive layer 4 has good adhesiveness.

Next, as shown in FIG. 14(b), the gripping frame 30 is brought down to press the decorative sheet 110 against a formed product body 121. In this process step, first, a portion 110a of the decorative sheet 110 is attached to the formed product body 121 as shown in FIG. 14(b).

Subsequently, the decorative sheet 110 is pressurized by introducing compressed air into the space over the decorative sheet 110. As a result, the other portion 10b of the decorative sheet 110 is also bonded onto the formed product body 121, which is now covered entirely with the decorative sheet 110 as shown in FIG. 14 (c). After that, excessive portions of the decorative sheet 110 are cut off to complete a decorated formed product.

In this series of process steps, the portion 110a of the decorative sheet 110 that contacts with the formed product body 121 earlier is cooled more quickly due to conduction of heat into the formed product body 121 than the other portion 110b that contacts with the formed product body 121 later. For example, if a decorative sheet 110 that has been heated to a temperature of 180° C. to 190° C. is attached, the portion 110b that is still out of contact with the formed product body 121 has a temperature of 150° C. to 170° C., but the temperature of that portion 110a in contact with the formed product body 121 decreases to somewhere between 60° C. and 120° C., in the process step shown in FIG. 14(b). That is why the flowability of the adhesive is lower in the portion 110a in contact with the formed product body 121 than in the non-contacting portion 110b.

Also, in this series of process steps, the base member 1 of the decorative sheet 110 is once stretched so as to fit the surface shape of the formed product body 121 closely and then is cooled and shrinks. FIG. 14(b) shows the direction in which the base member 1 is stretched and the direction in which the base member 1 shrinks. As the base member 1 shrinks, the adhesive in the adhesive layer 4 on the base member 1 flows in the direction in which the base member 1 shrinks. The shifted adhesive stays in the vicinity of the boundary between a region where the adhesive has high flowability (i.e., the portion 110b that will contact with the formed product body 121 later) and a region where the adhesive has low flowability (i.e., the portion 110a that has already contacted with the formed product body 121). As a result, as shown in the enlarged circle in FIG. 14(c), the adhesive layer 4 gets raised around that boundary. Consequently, the decoration layer 2 and the base member 1 located over the adhesive layer 4 also get raised just like the adhesive layer 4, thus making a string of uneven gloss sensible.

As described above, according to the conventional method, the uneven distribution of the adhesive will produce the uneven gloss and diminish the beauty of its appearance. On the other hand, in a method of making a decorated formed product according to a preferred embodiment of the present invention, such a diminution in the beauty of appearance is minimized by using a first sheet including an adhesive layer (an “adhesive sheet”) and a second sheet including a decoration layer (a “decorative sheet”).

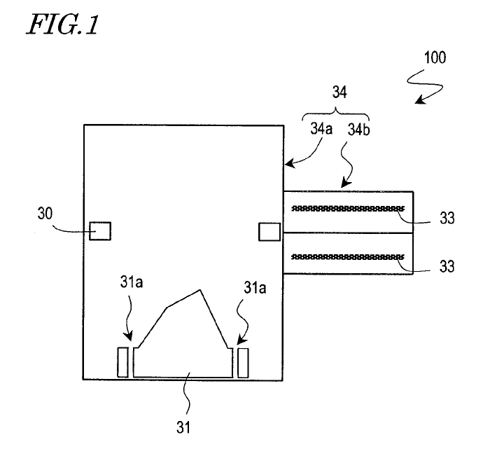

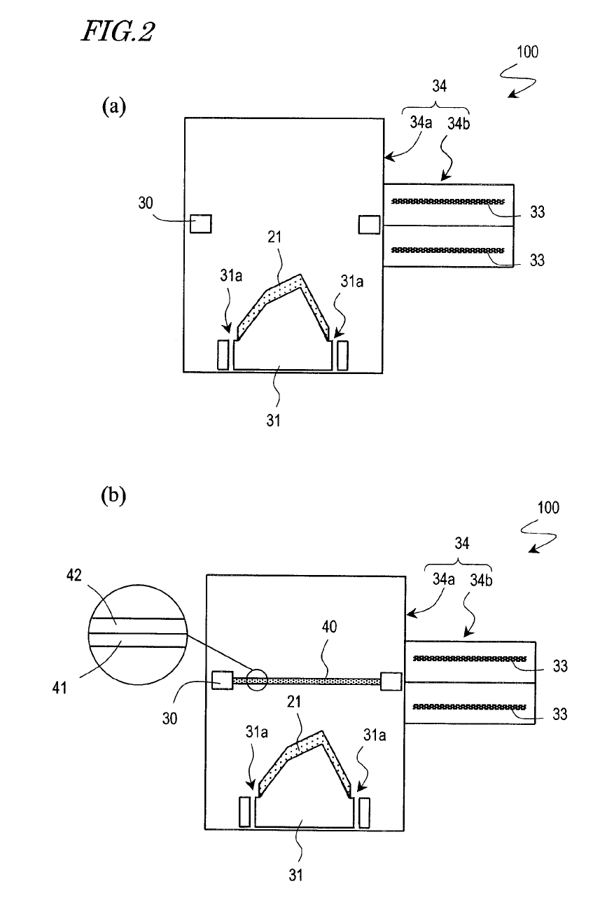

Hereinafter, a manufacturing process according to a preferred embodiment of the present invention will be described with reference to FIGS. 1 through 7. FIG. 1 schematically illustrates a vacuum forming system 100 for use to make a decorated formed product. FIGS. 2 through 7 are cross-sectional views schematically illustrating respective processing steps of the manufacturing process.

The vacuum forming system 100 shown in FIG. 1 includes a gripping frame 30 to grip an adhesive sheet or a decorative sheet thereon, a supporting stage 31 for supporting a formed product body thereon, a heater (such as a far-infrared heater) 33 for heating the adhesive sheet and the decorative sheet, and a vacuum vessel 34 that stores all of these members.

The vacuum vessel 34 consists of a main vessel 34a that stores the gripping frame 30 and the supporting stage 31, and a sub-vessel 34b that stores the heater 33. When the adhesive sheet or the decorative sheet is heated, the heater 33 is introduced into the main vessel 34a.

The supporting stage 31 has a plurality of openings 31a, through which the air inside the main vessel 34a can be exhausted. Although not shown in FIG. 1, a mechanism for introducing a gas from outside of this system into the main vessel 34a (e.g., a hose connected to an external pump) is also provided for the main vessel 34a.

Using this vacuum forming system 100, a decorated formed product may be made in the following manner, for example.

First, as shown in FIG. 2(a), a formed product body 21 is provided and mounted on the supporting stage 31. The formed product body 21 may be made of a resin material, a metallic material or any other suitable material by a known technique. For example, the formed product body 21 may be made of a resin material by an injection molding process.

Next, as shown in FIG. 2(b), an adhesive sheet 40 is provided and fixed onto a gripping frame 30, which is arranged over the formed product body 21. As partially enlarged in FIG. 2(b), the adhesive sheet 40 of this preferred embodiment includes an adhesive layer 41 and a supporting layer 42 that supports the adhesive layer 41 thereon. The adhesive layer 41 is made of a material that adheres well to the formed product body 21 (such as a resin adhesive). Meanwhile, the supporting layer 42 will be removed from the adhesive layer 41 later, and therefore, should be made of a material that can be easily peeled off the material of the adhesive layer 41.

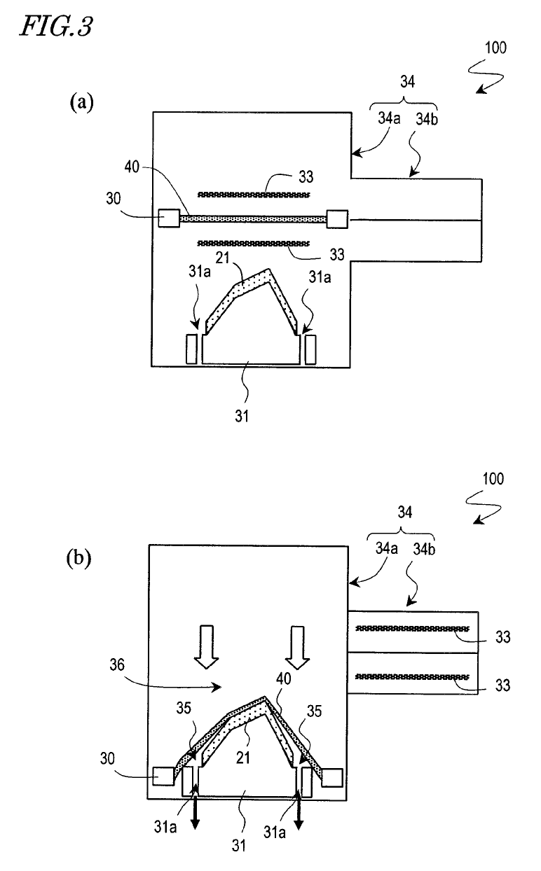

Subsequently, as shown in FIG. 3(a), the adhesive sheet is heated with a heater 33. In this process step, the adhesive sheet 40 is preferably heated to a temperature that is preferably about 20 to about 30° C. higher than the lowest adhesion temperature of the adhesive layer 41 to ensure good adhesiveness for the adhesive layer 41.

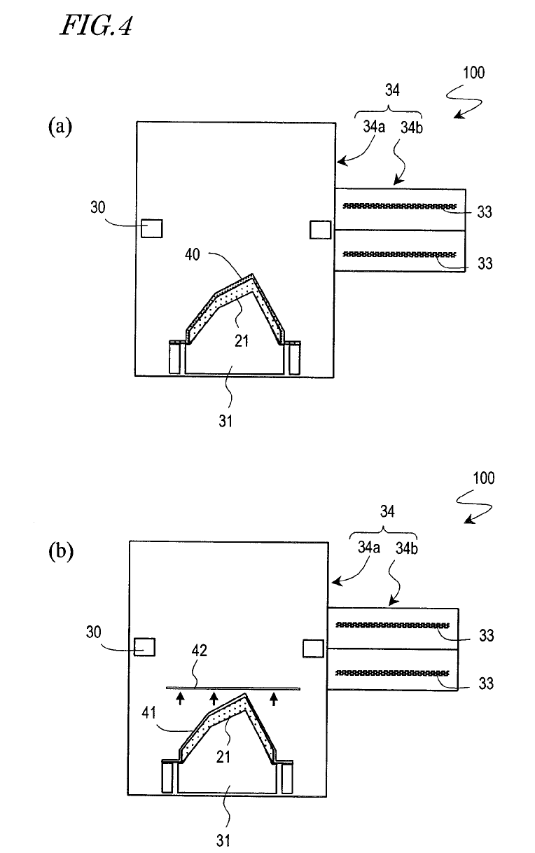

Thereafter, as shown in FIG. 3(b), the adhesive sheet is brought down toward the formed product body 21 and then the pressure in the space 35 between the adhesive sheet 40 and the formed product body 21 is reduced, thereby bonding the adhesive sheet 40 onto the formed product body 21 as shown in FIG. 4 (a). If the pressure in the space 35 between the adhesive sheet 40 and the formed product body 21 is reduced, then the adhesive sheet 40 will be pressed against the formed product body 21 with uniform pressure. As a result, the sheet 40 can be bonded to the body 21 effectively. In this preferred embodiment, the space 36 over the adhesive sheet 40 is also pressurized, thereby making an even bigger pressure difference. Consequently, the adhesive sheet 40 can be bonded even more quickly. The pressure in the space 35 may be reduced by exhausting the air in the space 35 through the openings 31a of the supporting stage 31 using a vacuum pump, for example. On the other hand, the pressure in the space 36 may be increased by supplying compressed air thereto using a compressor, for example.

Subsequently, as shown in FIG. 4(b), the supporting layer 42 of the adhesive sheet 40 is peeled off the adhesive layer 41. The supporting layer 42 may be removed by getting the edges of the supporting layer 42 peeled off either by a person's hand or a robot.

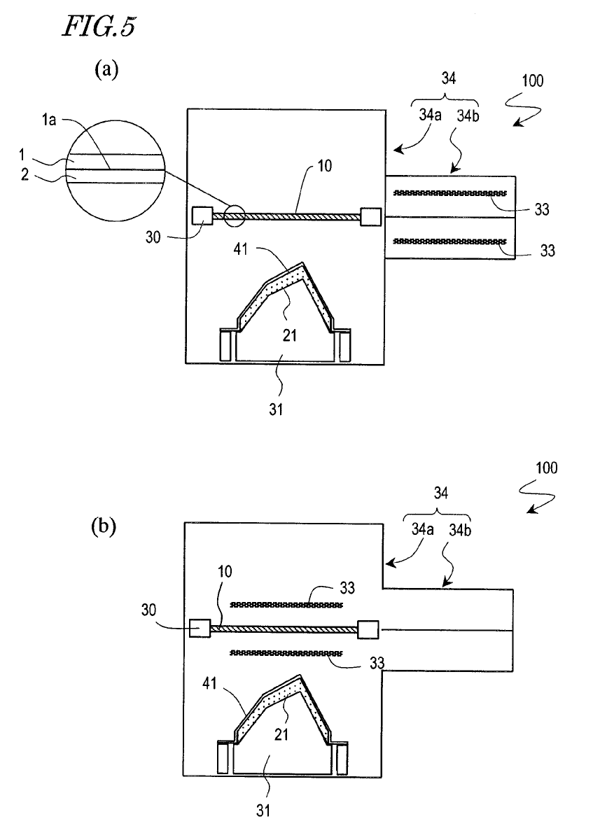

Thereafter, as shown in FIG. 5(a), a decorative sheet 10 is provided and fixed onto the gripping frame 30. As partially enlarged in FIG. 5(a), the decorative sheet 10 of this preferred embodiment includes a decoration layer 2 and a base member 1 that supports the decoration layer 2 thereon. The decoration layer 2 is arranged on one principal surface 1a (i.e., the principal surface closer to the formed product body 21). The decoration layer 2 may be formed by printing ink, for example. As shown in FIG. 5(a), no adhesive layer is provided on the surface of the decoration layer 2 that is opposed to the formed product body 21. Also, the base member 1 of this preferred embodiment is made of a thermoplastic resin.

Subsequently, as shown in FIG. 5(b), the decorative sheet 10 is heated with the heater 33, thereby softening the decorative sheet 10. In this process step, the decorative sheet 10 is preferably heated to a temperature of (TA−40)° C. to (TA+20) ° C., where TA is the load deflection temperature of the base member 1. This range is preferred for the following reasons. Specifically, if the decorative sheet 10 were heated to a temperature lower than (TA−40)° C., then the base member 1 would not be deformed easily and could crack when bonded to the formed product body and formed into a desired shape or could even be non-formable at all. On the other hand, if the decorative sheet 10 were heated to a temperature higher than (TA+20)° C., the sheet being heated could stretch too much to be formed into a desired shape. Typically, the decorative sheet 10 is heated to a temperature that is equal to or higher than the load deflection temperature TA of the base member 1. The load deflection temperature is measured under a prescribed load (of about 0.45 MPa, for example) compliant with the ASTM D648 standard, which is a standard method of measuring a load deflection temperature that was set by the American Society for Testing and Materials. According to this standard, the temperature of a test piece is raised under a prescribed bending load and the temperature at which the deflection of the piece reaches a predetermined value is defined as the load deflection temperature.

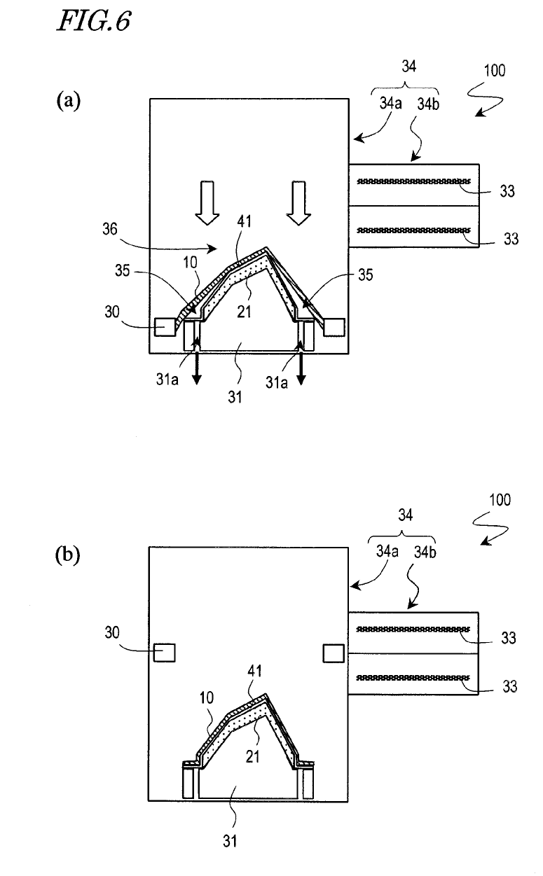

Thereafter, as shown in FIG. 6(a), the decorative sheet 10 is brought down toward the formed product body 21 and then the pressure in the space 35 between the decorative sheet 10 and the formed product body 21 is reduced, while the pressure in the space 36 over the decorative sheet 10 is increased. In this manner, the decorative sheet 10 is bonded onto the formed product body 21 as shown in FIG. 6(b). In this process step, the decorative sheet 10 is stretched and formed so as to fit the surface shape of the formed product body 21 closely. If the decorative sheet 10 were too thin, then the beauty of its appearance would diminish. That is why this process step is preferably carried out such that the thickness of the decorative sheet 10 bonded becomes at least about 0.4 times as large as, more preferably, about 0.5 or more times as large as, the original thickness.

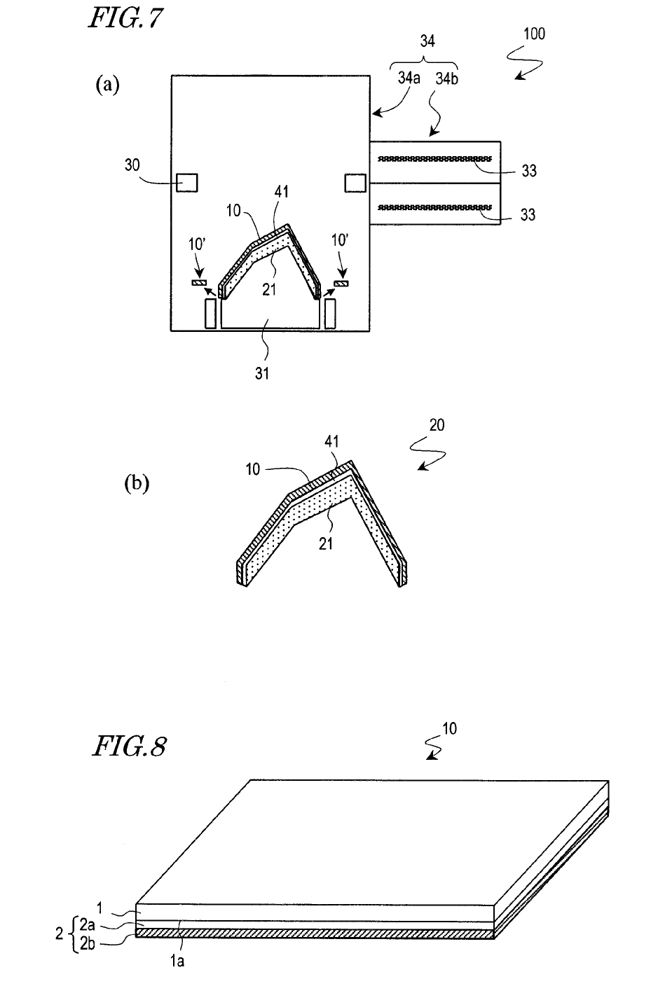

Subsequently, as shown in FIG. 7(a), an excessive portion 10′ of the decorative sheet 10 is trimmed with a rotating blade or any other cutter, and then the formed product body 21 is removed from the supporting stage 30, thereby completing a formed product 20 with a decorated surface as shown in FIG. 7(b).

In the manufacturing process of the preferred embodiment described above, first, the adhesive sheet 40 is put on the formed product body 21, and then the decorative sheet 10 heated is put on the adhesive sheet 40, thereby bonding the formed product body 21 and the decorative sheet 10 together. That is to say, in the process step of attaching the decorative sheet 10, the adhesive layer 41 is already present on the formed product body 21, not on the decorative sheet 10.

That is why the adhesive in the adhesive layer 41 is not easily affected by the shrinkage of the base member 1 of the decorative sheet 10 and does not get wrinkled easily, either. In addition, when the decorative sheet 10 is attached, not only the temperature but also the flowability of the adhesive are almost uniform all over the adhesive layer 41. That is why the adhesive is not easily raised locally unlike the adhesive shown in FIG. 14(c). Thus, in the manufacturing process of this preferred embodiment, the adhesive is rarely distributed unevenly, and therefore, the string of uneven gloss can be virtually eliminated and the diminution in the beauty of its appearance can be avoided.

Hereinafter, specific structures and preferred arrangements of the adhesive sheet 40 and the decorative sheet 10 will be described.

The adhesive layer 41 of the adhesive sheet 40 is preferably made of a urethane adhesive of a urethane resin or a urethane acrylate resin or an acrylic adhesive. To satisfy rigidity required for the product in its operating temperature range, the adhesive in the adhesive layer 41 preferably has an elasticity of about 1×103 Pa to about 1×106 Pa at 80° C. This temperature range is preferred for the following reasons. Specifically, if the elasticity at 80° C. were lower than about 1×103 Pa, then the adhesive would soften so much as to cause some problems when the product is used at a high temperature (e.g., used outdoors in summer). On the other hand, if the elasticity at 80° C. were higher than about 1×106 Pa, then the adhesive would be too hard to resist impact. To overlay the formed product with the adhesive easily to cover its three-dimensional shape perfectly, the adhesive preferably has an elasticity of about 1×101 Pa to about 1×105 Pa at 180° C. This temperature range is preferred for the following reasons. Specifically, if the elasticity at 180° C. were less than about 1×101 Pa, then the adhesive would flow so easily during the forming process that a pattern representing the adhesive flow could appear on the surface of the formed product. On the other hand, if the elasticity at 180° C. were higher than about 1×105 Pa, bubbles would be easily produced between the adhesive sheet 40 being bonded and the formed product body 21. The elasticity of the adhesive may be measured by a solid viscosity/elasticity measuring method compliant with JIS K7244-6 (or ISO 6721), for example.

The adhesive layer 41 preferably has a thickness of no less than about 30 μm and no more than about 100 μm. If the adhesive layer 41 had a thickness of less than about 30 μm, then the adhesive layer 41 could become too thin locally (e.g., to about 10 μm or less, which is too small a thickness for an adhesive layer) when the adhesive sheet 40 being bonded is stretched. On the other hand, if the adhesive layer 41 had a thickness of greater than about 100 μm, then a portion of the adhesive layer 41 that has not been stretched sufficiently would easily create unevenness when the adhesive shrinks. It should be noted that as the adhesive sheet 40 being bonded is stretched, the adhesive layer 41 is also stretched and comes to have a reduced thickness. That is why the thickness of the adhesive layer 41 is preferably increased appropriately according to the surface shape (or the magnitude of the ruggedness) of the formed product body 21.

The supporting layer 42 that supports the adhesive layer 41 thereon may be made of a resin such as polypropylene or polyethylene terephthalate (PET). As the supporting layer 42, any of various films that are currently available as release films (which are also called “carrier films”) may be used.

To peel the supporting layer 42 off the adhesive layer 41 effectively, the force to peel the supporting layer 42 is preferably about 0.02N/25 mm width to about 0.10N/25 mm width. Also, to stretch the adhesive sheet 40 effectively when the adhesive sheet 40 is being bonded, the supporting layer 42 preferably stretches 300% or more in any of two directions that are parallel to its principal surface and that are perpendicular to each other. Furthermore, the supporting layer 42 is preferably made of a material that does not absorb water easily and that does not gather dust easily. The supporting layer 42 typically has a thickness of about 60 μm to about 200 μm.

The decoration layer 2 of the decorative sheet 10 is preferably made of ink including a resin material as a binder and a dye dispersed in the resin material. The material of the decoration layer 2 preferably has excellent thermal resistance and bend strength. For example, the ink disclosed in Japanese Patent Application Laid-Open Publication No. 2002-275405 has excellent thermal resistance and bend strength, and therefore, can be used effectively as the material of the decoration layer 2.

The decoration layer 2 does not have to be a single layer but may include multiple layers. Also, the decoration layer 2 may include not only an ink layer 2a but also a metal layer 2b as shown in FIG. 8. If the decoration layer 2 includes a metal layer 2b, the decorative sheet 10 can have a metallic color, which gives the product a great-looking metallic appearance, due to the metallic gloss of the metal layer 2b.

The metal layer 2b may be made of tin, aluminum, gold, copper, zinc, silver, indium or an alloy thereof. Optionally, the decorative sheet 10 may consist essentially of the metal layer 2b without the ink layer 2a. The metal layer 2b may be formed by an evaporation process, for example. Specifically, the metal layer 2b may be formed by evaporating a metal directly on the base member 1 (or on the ink layer 2a). Alternatively, a metal may be evaporated on a carrier film provided separately and then the stack may be bonded onto the base member 1 (or the ink layer 2a) to form the metal layer 2b.

According to the conventional method, if a decorative sheet including a metal layer were used, then the string of uneven gloss would become even more noticeable to diminish the beauty of its appearance significantly. For that reason, the present invention is even more effective in a situation where the decorative sheet 10 includes a metal layer 2b.

The base member 1 of the decorative sheet 10 is preferably made of a thermoplastic resin such as polycarbonate or acrylic resin. The base member 1 should have some degree of rigidity that is high enough to serve as a sheet base member. That is why the material is preferably selected in view of this respect. Also, since the base member 1 will be located on the uppermost surface of the formed product after the decorative sheet 10 is attached to the formed product, the base member 1 preferably has good weather resistance and good damage resistance. For that reason, the other principal surface of the base member 1, which is opposite to the principal surface 1a with the decoration layer 2, may be covered with a protective layer with good weather resistance and good damage resistance.

The base member 1 preferably has a thickness of no less than about 50 μm and no more than about 1,000 μm. This is because if the base member 1 had a thickness of less than about 50 μm, the sheet would be difficult to handle or its mechanical strength could be too low to avoid tears when the sheet is being attached. On the other hand, if the thickness of the base member 1 exceeded about 1,000 μm, then the sheet could not fit closely the surface of the formed product 21.

The glass transition temperature of the base member 1 is typically higher than the melting point of the adhesive layer 41. According to the conventional method shown in FIGS. 14(a) through 14(c), if there were a big difference between the glass transition temperature of the base member 1 and the melting point of the adhesive layer 4 (i.e., if the melting point of the adhesive layer 4 were much lower than the glass transition temperature of the base member 1), then the adhesive would have so high flowability as to be distributed unevenly and diminish the beauty of its appearance easily when the decorative sheet 110 is heated and softened. In contrast, according to preferred embodiments of the present invention, even if the melting point of the adhesive layer 4 is much lower than the glass transition temperature of the base member 1 by about 30° C. or more, for example, fine appearance without gloss unevenness is realized.

As described above, according to preferred embodiments of the present invention, the string of uneven gloss can be virtually eliminated and the diminution in the beauty of its appearance can be minimized. For that reason, preferred embodiments of the present invention can be used effectively to decorate a formed product with significant ruggedness, e.g., to decorate a deep-drawn formed product.

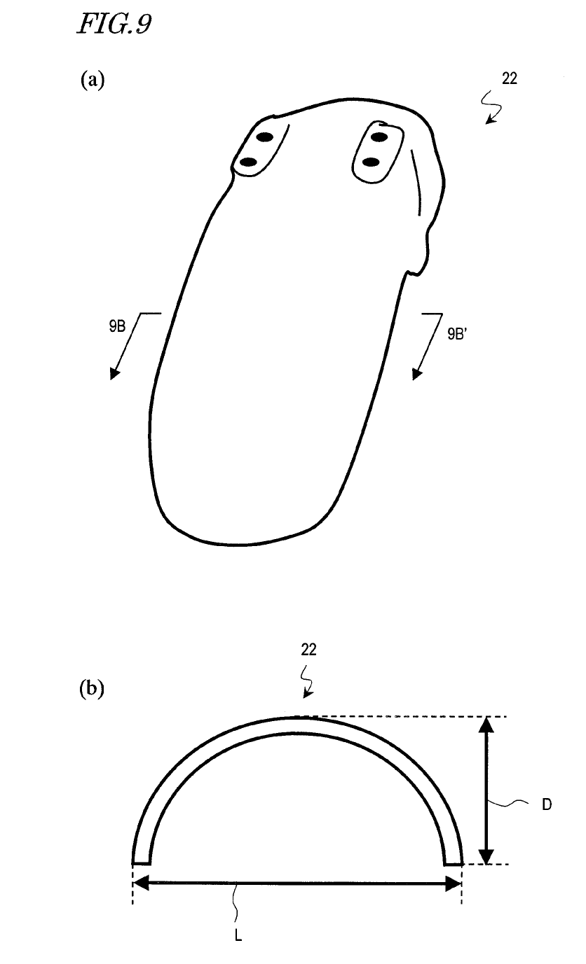

FIG. 9 illustrates an example of a deep-drawn formed product. The motorcycle fender 22 shown in FIG. 9 has a shape with a large D/L ratio (which will be referred to herein as a “draw ratio”), which is the ratio of the draw depth D to the draw diameter L (i.e., the width of a cross section of a formed product in the latitudinal direction). That is to say, the fender 22 has a deep-drawn shape. According to preferred embodiments of the present invention, the diminution in the beauty of appearance due to the uneven distribution of the adhesive can be minimized, and therefore, even a formed product with a relatively large draw diameter L and a rather high draw ratio D/L can also be decorated effectively. For example, according to the conventional method, if a formed product, of which the draw diameter L and draw depth D satisfy L≧100 mm and D/L≧⅓, is decorated, the beauty of its appearance diminishes significantly. However, according to preferred embodiments of the present invention, even a formed product with such a shape can also be decorated effectively without diminishing the beauty of its appearance.

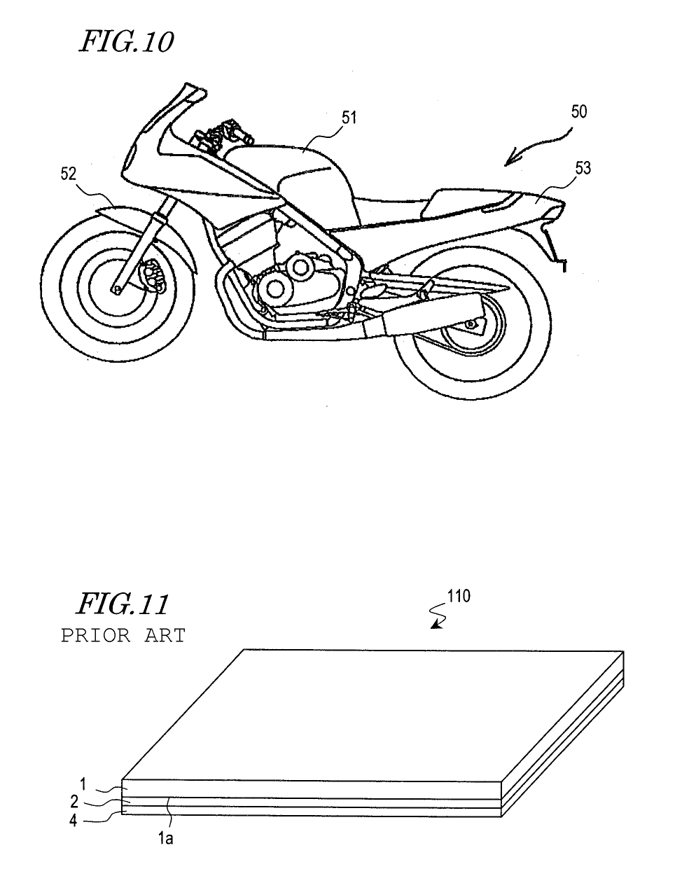

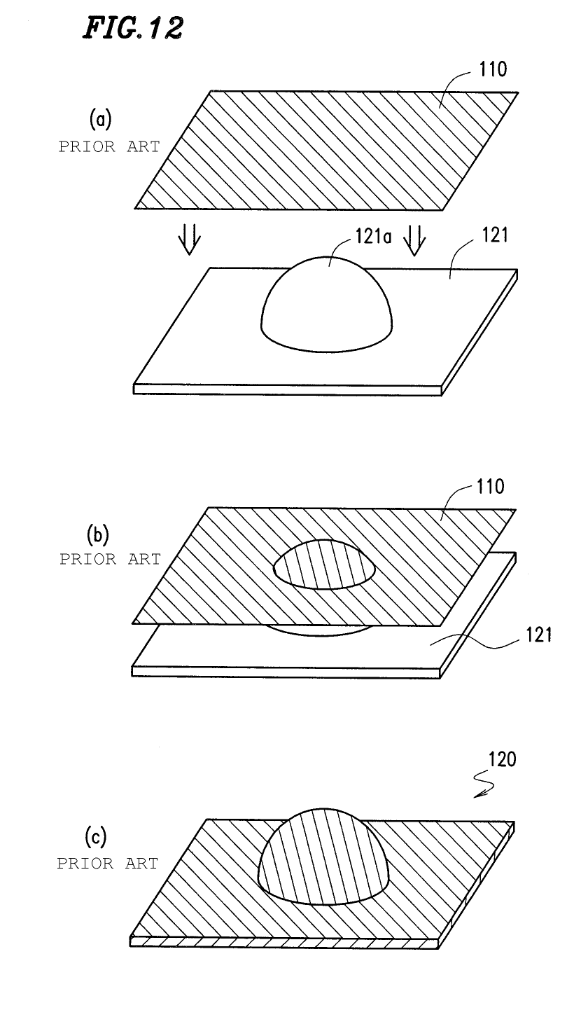

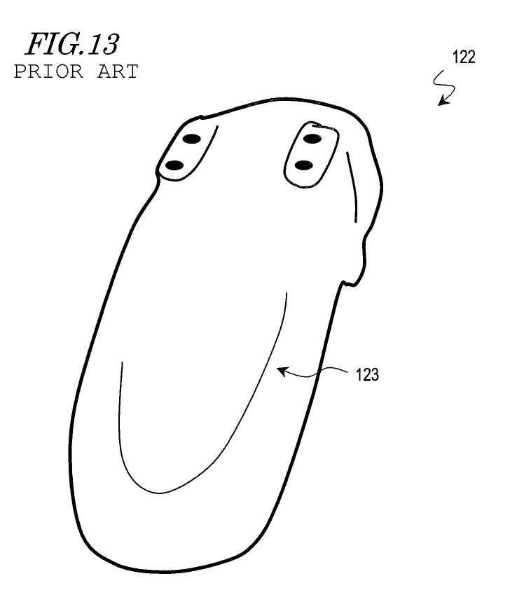

A formed product made by the manufacturing process according to preferred embodiments of the present invention can be used effectively as an interior or exterior member for a motor vehicle or as an exterior member for a consumer electronic appliance. For example, the formed product can be used effectively as the tank housing 51, the front fender 52 or the tail cowl 53 of a motorcycle 50 as shown in FIG. 10. As used herein, the “motor vehicle” broadly refers to a self-propelled vehicle or machine that is used to transport passengers or goods or to transfer an object. Examples of motor vehicles include passenger cars, motorcycles, buses, trucks, tractors, airplanes, motorboats, and civil engineering vehicles. The motor vehicles include not only vehicles equipped with an internal combustion engine such as a gasoline engine but also those equipped with an electric motor.

Also, in the formed product made by the process according to preferred embodiments of the present invention, the decoration layer 2 is protected by the base member 1 and can maintain a fine appearance for a long time. For that reason, the formed product made by the process according to preferred embodiments of the present invention can be used outdoors particularly effectively in ships, outboard engines, water vehicles, all terrain vehicles (ATVs), snowmobiles, two wheelers, and golf cars.

The present inventors actually made a decorated formed product by the manufacturing process of this preferred embodiment and evaluated its appearance. The results of the evaluation will be described below. The present inventors also made a decorated formed product by the conventional process and evaluated its appearance, the results of which will also be mentioned for the purpose of comparison.

### EXAMPLE #1

A cast polypropylene (CPP) carrier film with a thickness of 50 μm was used as a supporting layer and an adhesive layer of a urethane based adhesive UNH790, produced by Nihon Unipolymer Co., Ltd., was deposited to a thickness of 30 μm on this carrier film, thereby obtaining an adhesive sheet.

Meanwhile, a polycarbonate film Eupiron D01, produced by Mitsubishi Gas Chemical Co., Inc. and having a thickness of 0.8 mm, was used as a base member and a pattern was printed on this film with ink to make a decoration layer. In this manner, a decorative sheet was obtained.

Using an adhesive sheet and a decorative sheet thus obtained, a formed product was decorated in a vacuum forming system. Specifically, first, an adhesive sheet was heated and softened and then attached to the formed product body. Next, the supporting layer of the adhesive sheet was peeled off the adhesive layer. And then the decorative sheet was heated, softened and attached to the formed product.

### EXAMPLE #2

A CPP carrier film with a thickness of 50 μm was used as a supporting layer and an adhesive layer of an adhesive Elfan, produced by Nihon Matai Co., Ltd., was deposited to a thickness of 50 μm on this carrier film, thereby obtaining an adhesive sheet. Meanwhile, a decorative sheet was made as in the first specific example. Then, using these adhesive and decorative sheets, a formed product was decorated within a vacuum forming system as in the first specific example.

### EXAMPLE #3

A PET carrier film with a thickness of 60 μm was used as a supporting layer and an adhesive layer of an adhesive UNH785, produced by Nihon Unipolymer Co., Ltd., was deposited to a thickness of 40 μm on this carrier film, thereby obtaining an adhesive sheet. Meanwhile, a decorative sheet was made as in the first specific example. Then, using these adhesive and decorative sheets, a formed product was decorated within a vacuum forming system as in the first specific example.

### COMPARATIVE EXAMPLE #1

A polycarbonate film Eupiron D01, produced by Mitsubishi Gas Chemical Co., Inc. and having a thickness of 0.8 mm, was used as a base member and a pattern was printed on this film to make a decoration layer. Thereafter, a urethane based adhesive UNH790, produced by Nihon Unipolymer Co., Ltd., was dry-laminated on this decoration layer to form an adhesive layer with a thickness of 30 μm. A decorative sheet obtained in this manner (including an adhesive layer) was heated, softened and then attached to a formed product body within a vacuum forming system.

### COMPARATIVE EXAMPLE #2

A polycarbonate film with a thickness of 0.5 mm was used as a base member and a metal layer of tin was deposited to a thickness of 0.1 μm on this film. The metal layer was formed by evaporating tin on an acrylic resin film with a thickness of 50 μm and then attaching this film onto the base member. Thereafter, a urethane based adhesive UNH385, produced by Nihon Unipolymer Co., Ltd., was dry-laminated on this metal layer to form an adhesive layer with a thickness of 30 μm. A decorative sheet obtained in this manner (including an adhesive layer) was heated, softened and then attached to a formed product body within a vacuum forming system.

### Results of Appearance Evaluation

The following Table 1 summarizes the results of appearance evaluations that were carried out on Examples #1, #2 and #3 and Comparative Examples #1 and #2:

where ∘ indicates that fine appearance with no strings of uneven gloss was realized, Δ indicates that the beauty of its appearance was diminished to a certain degree due to the presence of several strings of uneven gloss, and x indicates that the beauty of its appearance was diminished significantly due to the presence of a lot of strings of uneven gloss.

TABLE 1

| | Ex. 1 | Ex. 2 | Ex. 3 | Cmp. Ex. 1 | Cmp. Ex. 2 |
|---|---|---|---|---|---|
| Results of | ∘ | ∘ | ∘ | Δ | x |
| appearance | | | | | |
| evaluation | | | | | |

As can be seen from Table 1, no strings of uneven gloss were seen in any of Examples #1, #2 and #3 and fine appearance was realized. In Comparative Example #1, however, several strings of uneven gloss were seen and diminished the beauty of their appearance. Furthermore, in Comparative Example #2 including a metal layer as a decorative sheet, a lot of strings of uneven gloss were seen and diminished the beauty of their appearance significantly. Consequently, it was confirmed that according to preferred embodiments of the present invention, a decorated formed product could be made effectively with a decorative sheet and without diminishing the beauty of its appearance.

Also, the following Table 2 shows the glass transition temperature T_{g} of the base member, the melting point Tₘ of the adhesive, the difference between these two temperatures, and the elasticity of the adhesive for each of Examples #1, #2 and #3 in which no strings of uneven gloss were seen:

TABLE 2

| | | | Glass transition | Melting | | | | |
|---|---|---|---|---|---|---|---|---|
| | | | temperature Tg | point Tm | Tg − Tm | Adhesive elasticity | | Non-uniform |
| Ex | Base member | Adhesive | of base member | of adhesive | difference | 80° C. | 180° C. | gloss |
| 1 | Polycarbonate | UHN790 | 145° C. | 105° C. | 40° C. | 8.7 × 10⁵ | 1.1 × 10² | NO |
| 2 | Polycarbonate | Elfan | 145° C. | 95° C. | 50° C. | 1.0 × 10⁶ | 0.9 × 10² | NO |
| 3 | Polycarbonate | UHN785 | 145° C. | 100° C. | 45° C. | 7.5 × 10⁵ | 1.0 × 10² | NO |

As can be seen from Table 2, in each of Examples #1, #2 and #3, the melting point of the adhesive was lower than the glass transition temperature of the base member by 30° C. or more. Also, in any of Examples #1, #2 and #3, the elasticity of the adhesive at 80° C. was in the range of 1×10³ Pa to 1×10⁶ Pa and the elasticity of the adhesive at 180° C. was in the range of 1×10¹ Pa to 1×10⁵ Pa.

Thus, it was confirmed that by setting the elasticity of the adhesive within any of these ranges, fine appearance without uneven gloss was realized even when there was a big difference between the glass transition temperature of the base member and the melting point of the adhesive (i.e., in a situation where the adhesive would be distributed unevenly according to the conventional method).

According to the manufacturing process of various preferred embodiments of the present invention, a decorated formed product can be made effectively with a decorative sheet without diminishing the beauty of its appearance.

The appearance of a formed product made by the manufacturing process according to preferred embodiments of the present invention is so fine that the product can be used effectively as an exterior or interior member for any of various motor vehicles or as an exterior member for any of numerous consumer electronic appliances.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1-10. (canceled)

11. A method of making a decorated formed product with a decorated surface, the method comprising the steps of:
(A) providing a formed product body;
(B) mounting a first sheet, including an adhesive layer, on the formed product body;
(C) heating a second sheet including a decoration layer and a base member that supports the decoration layer thereon; and
(D) putting the heated second sheet on the first sheet, thereby bonding the second sheet onto the formed product body.

12. The method of claim 11, wherein the first sheet includes a supporting layer that supports the adhesive layer, and the method further includes removing the supporting layer from the adhesive layer before the step (D) is performed.

13. The method of claim 11, further comprising heating the first sheet before the step (B) is performed.

14. The method of claim 11, wherein the step (D) includes the steps of:
(D1) bringing the heated second sheet closer to the formed product body; and
(D2) creating a lower pressure in a first space, which is defined between the second sheet that is now located near the formed product body and the formed product body itself, than in a second space, which is defined on the opposite side of the second sheet over or under the first space.

15. The method of claim 11, wherein the step (D) includes forming the second sheet such that the second sheet covers the surface of the formed product body tightly.

16. The method of claim 11, wherein the melting point of the adhesive layer is lower than the glass transition temperature of the base member by at least about 30° C.

17. The method of claim 11, wherein the adhesive layer is made of a material that has an elasticity falling within the range of about 1×103 Pa to about 1×106 Pa at 80° C. and within the range of about 1×101 Pa to about 1×105 Pa at 180° C.

18. The method of claim 11, wherein the base member is made of a thermoplastic resin.

19. The method of claim 11, wherein the formed product body is formed by a deep-drawing process and has shape such that a draw diameter L and a draw depth D satisfy L≧100 mm and D/L≧⅓.

20. A motor vehicle comprising a formed product formed by the method of claim 11.
